(19) United States
(12) Patent Application Publication
(10) Pub. No.: US 2003/0041756 A1
(43) Pub. Date: Mar. 6, 2003

(54) Rotary printing press

(76) Inventors: Andreas Detmers, Heddesheim (DE); Arno Junger, Nussloch (DE); Jurgen Kreutzkamper, Sinsheim-Hoffenheim (DE); Sven Mader, Dielheim (DE); Christian Meier, Schriesheim (DE)

Correspondence Address: LERNER AND GREENBERG, P.A., Post Office Box 2480, Hollywood, FL, 33022-2480, US

(21) Appl. No.: 10/231,808

(22) Filed: Aug. 29, 2002

Related U.S. Application Data
(60) Provisional application No. 60/316,845, filed on Aug. 31, 2001.

(30) Foreign Application Priority Data
Aug. 29, 2001 (DE) 101 43 041.8

(51) Int. Cl. B41F 5/00

(52) U.S. Cl. 101/216

(57) ABSTRACT

A rotary printing press includes at least one form cylinder, a transmitting gear via which the form cylinder is drivable together with at least another cylinder during a printing operation, and a device for setting an image on a printing form disposed on the form cylinder. A freewheeling clutch is disposed, during the printing operation, between the form cylinder and the gear for driving the form cylinder. A separate drive is provided for driving the form cylinder during an image setting operation.

### CROSS-REFERENCE TO RELATED APPLICATION

This application claims the benefit of copending Provisional Application No. 60/316,845, filed Aug. 31, 2001.

### BACKGROUND OF THE INVENTION

Field of the Invention

The invention relates to a rotary printing press including at least one integrated imaging or image-setting device for a printing form which, during imaging, is fastened to a form cylinder driven rotatably relative to the imaging device.

A printing press of that general type is described in German Published, Non-Prosecuted Patent Application DE 197 23 147 A1, corresponding to U.S. Pat. No. 6,393,987. This printing press has two different drive systems. During the printing operation, all components of the printing press required for printing, which are mutually coupled via a gear train, are driven by a main drive. During the imaging or image setting operation, the form cylinder is driven separately by an auxiliary drive, the main drive being inactivated and the form cylinders being decoupled from the gear train with the aid of decoupling clutches. Deactivation of the main drive is necessary in order to prevent mechanical oscillations or vibrations and impacts, which would otherwise occur during the operation of the main drive, from influencing the imaging system made up of the imaging device and form cylinders. The mechanical vibrations and impacts would cause imaging and printing errors, respectively. During imaging, it is possible, besides driving the form cylinder with the aid of an auxiliary drive, also therewith to drive components which cause only small mechanical oscillations. After imaging, the form cylinder must be coupled into the main drive strand or loop in the correct or proper phase, for which special precautions must be taken. The in-phase reintegration of the form cylinder into the gear train can be monitored by measuring systems or performed by mechanical elements such as phase couplers.

In order to prevent printing errors, German Published, Non-Prosecuted Patent Application DE 44 03 673 A1 teaches how to compensate for mechanical oscillations or vibrations of the printing press during imaging, by corrective controlling of the imaging heads in the circumferential direction.

### SUMMARY OF THE INVENTION

It is accordingly an object of the invention to provide a rotary printing press which overcomes the hereinafore-mentioned disadvantages of the heretofore-known devices of this general type and in which low material and cost expenditures are required for driving a form cylinder in both printing and imaging operations performed therein.

With the foregoing and other objects in view, there is provided, in accordance with the invention, a rotary printing press, comprising at least one form cylinder, a transmitting gear via which the form cylinder is drivable together with at least another cylinder during a printing operation, and a device for setting an image on a printing form disposed on the form cylinder. A freewheeling clutch is disposed, during the printing operation, between the form cylinder and the gear for driving the form cylinder. A separate drive is provided for driving the form cylinder during an image setting operation.

In accordance with another feature of the invention, the freewheeling clutch further comprises clamping connecting pieces.

In accordance with a further feature of the invention, the connecting pieces are actable via a clamping ring on a shaft of the form cylinder.

In accordance with an added feature of the invention, the form cylinder is positionable by the separate drive at a defined angular position relative to the gear for driving the form cylinder during the printing operation, and is fixable in the defined angular position.

In accordance with an additional feature of the invention, the rotary printing press further comprises a sensor provided for detecting the angular position between the form cylinder and the gear for driving the form cylinder during the printing operation.

In accordance with a concomitant feature of the invention, the sensor provided for detecting the angular position is rotatable with the form cylinder and is directable to a marking on a side surface of the gear.

The utilization of a freewheeling clutch, which acts upon one side, between the form cylinder and the gear from the gear transmission or train for driving, during the printing operation, offers the advantage that the form cylinder can be brought to imaging speed at any time, with the aid of the separate drive, without engaging and disengaging operations, while the gear train of the main drive loop is stopped. With the separate drive, the form cylinder can be moved into the proper or correct phase relative to the gear train or transmission electrically or mechanically, for example, by a locking journal pin.

Other features which are considered as characteristic for the invention are set forth in the appended claims.

Although the invention is illustrated and described herein as embodied in a rotary printing press, it is nevertheless not intended to be limited to the details shown.

On the contrary, various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, side-elevational view of a four-color rotary printing press;

FIG. 2 is a cross-sectional, end view of a drive for a form cylinder of the printing press; and

FIG. 3 is an end view of the drive shown in FIG. 2.

### DESCRIPTION OF THE PREFERRED EMBODIMENTS

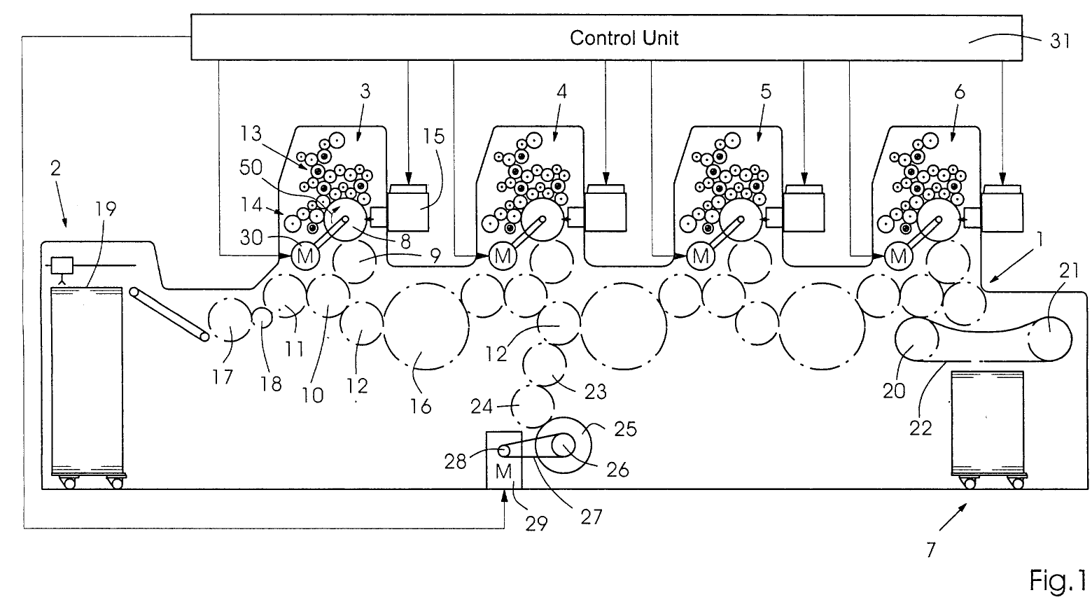

Referring now to the figures of the drawings in detail and, first, particularly to FIG. 1 thereof, there is seen a sheet-fed rotary printing press 1 having a feeder 2, four printing units 3, 4, 5 and 6, and a delivery 7. Each printing unit 3 to 6 has a form cylinder 8, a transfer cylinder 9, an impression cylinder 10, two transfer cylinders 11 and 12, a multiplicity of ink transfer rollers 13 and dampening-solution transfer rollers 14, as well as imaging mechanisms 15. Transfer rollers 16 are disposed between the printing units 3 to 6. Additional cylinders 17 and 18 serve for feeding sheets 19 to the first printing unit 3. Deflection cylinders 20 and 21 are located in the delivery 7, with chains 22 of a chain gripper system looped about the cylinders 20 and 21. The cylinders and rollers in the printing units 3 to 6, as well as all rotatably driven cylinders and drums, respectively, in the feeder 2 and the delivery 7, respectively, are connected to one another by a gear transmission or train. An additional gear train 23 to 25 meshes with the gear of the transfer cylinder 12 of the second printing unit 4. A pulley 26 of a belt drive 27 is located on the shaft of the gear 25. A second pulley 28 is seated on the shaft of a main drive motor 29. Moreover, auxiliary drive motors, 30 which are coupled directly with the form cylinders 8, are located in the printing units 3 to 6. The main drive motor 29 and the auxiliary drive motors 30 are connected to a control device 31 of the sheet-fed rotary printing press 1. Besides additional actuators and sensors, the imaging mechanisms 15 are also in contact with the control device 31.

During the printing operation, sheets 19 are transported from the feeder 2 to the delivery 7 through the printing units 3 to 6, the main drive motor 29 driving all of the components via the gear transmission or train. Harmonic and non-harmonic oscillations occur during the driving of the sheet-fed printing press 1 due to eccentricities, imbalance, and reciprocating assemblies, such as oscillation grippers or gripper mechanisms. The effects of the oscillations and impacts on the print quality are ameliorated by the high pressure exerted between the transfer cylinders 9 and the respective impression cylinders 10 during the printing operation.

In order to avoid circumferential and axial oscillations during the imaging operation, the form cylinders 8 are driven by the auxiliary drive motors 30, while driving by the sheet-fed rotary printing press 1 by the main drive motor 29 is disabled. Furthermore, the transfer cylinders 9 are disengaged from the form cylinders 8 and the printing cylinders 10 during the printing operation.

According to the invention, the form cylinders 8 are driven via self-blocking freewheels between the respective form cylinder 8 and the drive gear of the respective transfer cylinder 9, without additional controllable or switchable couplers.

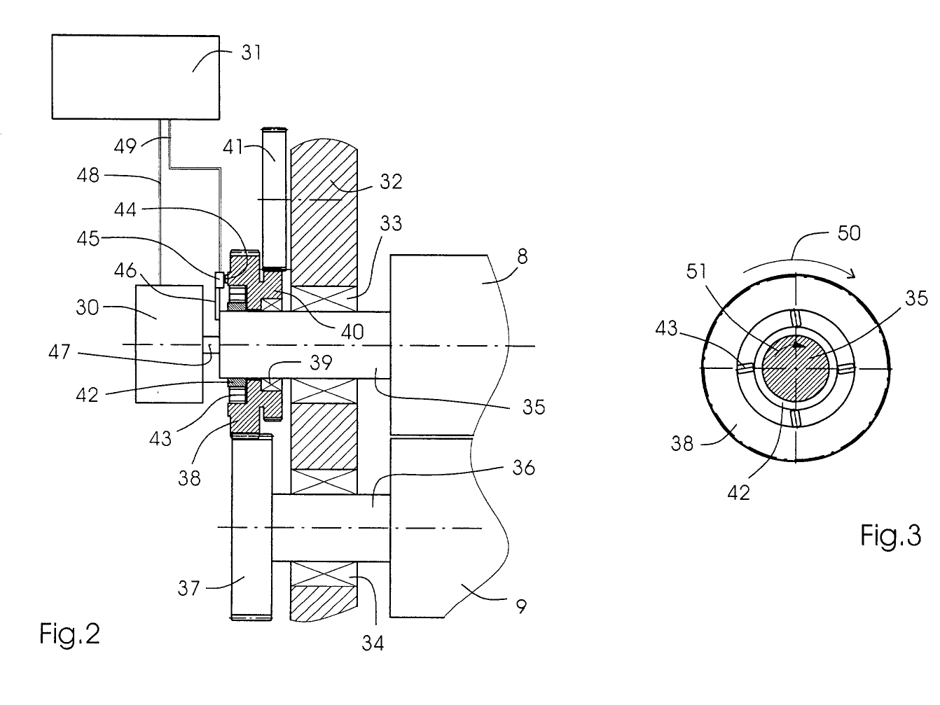

FIGS. 2 and 3 represent, with reference to the printing unit 3, how the form cylinders 8 are driven during the imaging operation. FIG. 2 shows a side wall 32 of the sheet-fed rotary printing press 1. The sidewall 32 is formed with openings containing bearings 33 and 34 for receiving shaft journals 35 and 36, respectively, of the form cylinder 8 and the transfer cylinder 9. A gear 37 of the gear train or transmission for driving the transfer cylinder 9 during printing is fixed on the shaft journal 36. A gear 38 rotates in a bearing 39 mounted on the shaft journal 35. The gear 38 is structurally united with an additional gear 40 for driving an inking and dampening unit. The gear 38 is continuously engaged with the gears 37, and the gear 40 is continuously engaged with another gear 41.

The gear 38 is formed with a bored portion wherein a self-blocking freewheel or slipping clutch is located, which is formed of a clamping ring 42 at the surface of the shaft journal 35 and of four connecting pieces 43 which are evenly distributed in the circumferential direction of the bored portion of the gear 38. A marking 44 which can be detected by a sensor 45 is applied to the face of the gear 38. The sensor 45 is seated on a holder 46, which is fixed to the shaft journal 35. For driving the form cylinder 8 during the imaging operation, the axle 47 of the auxiliary drive motor 30 is coupled directly with the shaft journal 35. The auxiliary drive motor 30 and the sensor 45 are connected to the control device 31 by way of lines 48 and 49, respectively.

During the printing operation, the gear 37 is driven by the main drive motor 29. The gears 38, 40 and 41 which are connected to the gear 37 rotate in the direction indicated by the arrow 50. When rotation is in the direction 50, the connecting pieces 43 are clamped between the bored portion in the gear 38 and the clamping ring 42. The clamping ring 42 is pressed against the shaft journal 35 by radial forces, so that the shaft journal is entrained simultaneously and in synchronism with the rotation of the transfer cylinder 9.

During the imaging operation, the main drive motor 29 is stopped, due to which the gears 37, 38, 40 and 41 are stopped or at standstill. The auxiliary drive motor 30 drives the form cylinder 8 in the direction represented by the arrow 51. The clamping of the connecting pieces 43 and, therewith, the pressing of the clamping ring 42 against the shaft journal 35 are discontinued. The imaging of the printing form located on the form cylinder 8 is accomplished without the mechanical disturbances which would occur during the printing operation due to the driven elements. The auxiliary drive motor 30 allows for imaging at a higher form-cylinder speed than during the printing operation. With a rotary transducer which is coupled with the form cylinder 8, it is possible to determine instantaneous speed of rotation and cylinder position. These signals can be processed in the control device 31, in order to control the imaging. It is not necessary to shut down the main drive motor 29 if the elements which are driven by the gear transmission or train during the printing operation operate within a speed range such as a crawl speed, for example, wherein, it is quite certain that disturbing oscillations or impacts will not occur. In this way, due to the aforementioned elements, the processes preparatory to the printing process, such as washing and exchanging printing forms, for example, can be performed.

After the imaging or image setting of the printing form on the form cylinder 8, the form cylinder 8 and the transfer cylinder 9 must have the correct phase relative to one another. To this end, the form cylinder 8 and, therewith, the sensor 45 must be brought or moved, by the auxiliary drive motor 30, into an angular position wherein the sensor 45 is situated opposite the marking 44. The signal of the sensor 45 is evaluated in the control device 31, in order to derive control signals for the auxiliary drive motor 30. In this position, the gear 38 is fixed on the shaft journal 35, in that the precise blocking point of the freewheel is controlled by electronics. Alternatively, the gear 38 can be oriented and fixed in the correct or proper phase relative to the form cylinder 8 by mechanical elements, such as stops and locking journal pins.

We claim:

1. A rotary printing press, comprising:
at least one form cylinder;
a transmitting gear for driving said form cylinder together with at least another cylinder during a printing operation;
a device for setting an image on a printing form disposed on said form cylinder;
a freewheeling clutch disposed between said form cylinder and said gear, during the printing operation, for driving said form cylinder; and
a separate drive for driving said form cylinder during an image setting operation.

2. The rotary printing press according to claim 1, wherein said freewheeling clutch has clamping connecting pieces.

3. The rotary printing press according to claim 2, which further comprises a shaft for said form cylinder, and a clamping ring, said shaft to be acted upon by said connecting pieces through said clamping ring.

4. The rotary printing press according to claim 1, wherein said form cylinder is to be positioned by said separate drive at a defined angular position relative to said gear for driving said form cylinder during the printing operation and is to be fixed in said defined angular position.

5. The rotary printing press according to claim 4, which further comprises a sensor for detecting said angular position between said form cylinder and said gear for driving said form cylinder during the printing operation.

6. The rotary printing press according to claim 5, wherein said sensor for detecting said angular position is rotatable with said form cylinder and is to be directed to a marking on a side surface of said gear.
